(19) United States
(12) Patent Application Publication
(10) Pub. No.: US 2014/0064639 A1
(43) Pub. Date: Mar. 6, 2014

(54) INFORMATION PROCESSING APPARATUS, INFORMATION PROCESSING METHOD, AND INFORMATION PROCESSING PROGRAM

(71) Applicant: Sony Corporation, Tokyo (JP)

(72) Inventors: Kenji Yamane, Kanagawa (JP); Hirofumi Watanabe, Kanagawa (JP); Seiji Miyama, Kanagawa (JP); Hiroshi Kyusojin, Tokyo (JP); Naoki Tagami, Tokyo (JP)

(73) Assignee: Sony Corporation, Tokyo (JP)

(21) Appl. No.: 13/969,238

(22) Filed: Aug. 16, 2013

(30) Foreign Application Priority Data
Aug. 28, 2012 (JP) 2012-187478

(51) Int. Cl. G06T 3/40

(52) U.S. Cl. CPC G06T 3/4092
USPC 382/299

(57) ABSTRACT

Provided is an information processing method, including: receiving a request for a partial image from a terminal, the partial image being at least a part of a first-format pathological image, the first-format pathological image including a plurality of layers of first images having different resolutions, the terminal being capable of displaying the first-format pathological image; obtaining a layer of second-format pathological image having a resolution corresponding to the received request, the second format being different from the first format; converting the obtained layer of second-format pathological image into a first-format pathological image having a corresponding resolution; storing the converted first-format pathological image; and extracting the partial image corresponding to the received request from the stored first-format pathological image in response to the received request, and replying the partial image to the terminal.

### CROSS REFERENCES TO RELATED APPLICATIONS

The present application claims priority to Japanese Priority Patent Application JP 2012-187478 filed in the Japan Patent Office on Aug. 28, 2012, the entire content of which is hereby incorporated by reference.

### BACKGROUND

The present disclosure relates to an information processing apparatus configured to display an image obtained by using a microscope. The present disclosure further relates to an information processing method and an information processing program.

In the past, the following system is known. An optical microscope obtains an image of an observation target. The image is digitalized. The digital image is used for any purpose as necessary. For example, Japanese Patent Application Laid-open No. 2011-112523 discloses the following system. In the field of medical care, pathology, or the like, an optical microscope obtains an image of cells, tissues, an organ, or the like of a living body. A doctor, a pathologist, or the like examines the tissues or the like in the image. Alternatively, a doctor, a pathologist, or the like diagnoses a patient by using the image (see Japanese Patent Application Laid-open No. 2011-112523, paragraphs [0002], [0003], etc.).

The system of Japanese Patent Application Laid-open No. 2011-112523 uses an image pyramid structure as shown in FIG. 2 of this application. A microscope takes a picture of one observation object to thereby obtain an image at a plurality of different resolutions. The image pyramid structure is an image group of one image at the plurality of different resolutions. A user selects an arbitrary image from the image group. An image of an arbitrary area of the selected image is displayed. Because the image pyramid structure is used, a user may have the feeling as if he observes an observation target while an observe magnification is being changed (see specification of Japanese Patent Application Laid-open No. 2011-112523, paragraphs [0032] to [0040], etc.).

### SUMMARY

In most cases, such an image obtained by using an optical microscope may be large data. For example, the above-mentioned image pyramid structure requires data of a plurality of images. Further, an image having the largest size is at the lowermost layer of the image pyramid structure. The image having the largest size is about 50×50 Kpixels (kilopixels) (described in Japanese Patent Application Laid-open No. 2011-112523, paragraph [0033]). It is desirable to process such large image data in a short time. For example, it is desirable to convert an image having a different format into an optimum format in a short time, and to display the converted image in a short time. Further, in a case where such large image data is converted into an optimum format and stored in a hard disk, for example, the large image data wastes large disk space.

In view of the above-mentioned circumstances, it is desirable to provide an information processing apparatus, an information processing method, and an information processing program configured to optimize format conversion of an image.

(1) According to an embodiment of the present application, there is provided an information processing apparatus, including: a receiving section configured to receive a request for a partial image from a terminal, the partial image being at least a part of a first-format pathological image, the first-format pathological image including a plurality of layers of first images having different resolutions, the terminal being capable of displaying the first-format pathological image; an obtaining section configured to obtain a layer of second-format pathological image having a resolution corresponding to the received request, the second format being different from the first format; a conversion section configured to convert the obtained layer of second-format pathological image into a first-format pathological image having a corresponding resolution; storage configured to store the converted first-format pathological image; and a responding section configured to extract the partial image corresponding to the received request from the stored first-format pathological image in response to the received request, and to reply the partial image to the terminal.

According to the present application, a first-format pathological image includes first images having different resolutions. The first images are at a plurality of layers, respectively. A user may instruct a terminal to display an image at a specific location in an image of a specific layer (resolution) by using the terminal. Further, a user may instruct the terminal to display an image corresponding to a specific tile number (number assigned to each tile of a pathological image, which is divided into tiles) by using the terminal. For example, let's say that a first format is an own-company's format, and a second format is a different-company's format. The terminal is not capable of displaying an image of the different-company's format as it is. In this case, it is necessary to convert data of the first format into the second format. According to the present application, images of all the layers of a second-format pathological image are not converted all at once. Instead, only an image of a layer corresponding to a resolution, which is requested from the terminal, is converted. The converted image is replied to the terminal. As a result, it takes a shorter time to convert a format and to display a converted image on a terminal.

Note that data may be up-converted or down-converted. As a result, a first-format image, which has a resolution different from the resolution of a second-format image, may be created. That is, the number of layers of an image before data conversion is not necessarily the same as the number of layers of an image after data conversion.

(2) According to an embodiment of the present application, in the information processing apparatus, the receiving section may be configured to receive the request from the terminal, the request including location information and resolution information of the partial image.

(3) According to an embodiment of the present application, in the information processing apparatus, the conversion section may be configured to convert at least an encoding scheme of a pathological image.

(4) According to an embodiment of the present application, the information processing apparatus may further include: a controller configured to determine if the storage stores the first-format pathological image corresponding to the location information and the resolution information in the received request, and in a case where the storage fails to store the first-format pathological image, to cause the obtaining section to obtain a layer of pathological image having a resolution corresponding to the resolution information in the received request, and to cause the conversion section to convert the obtained pathological image.

According to the present application, the controller determines if the storage already stores an image requested from the terminal or not. Only in a case where the storage does not store the image, a second-format image is converted. As a result, it is possible to prevent needless conversion processing from being executed.

(5) According to an embodiment of the present application, in the information processing apparatus, the controller may be configured, in a case where the controller determines that the storage stores the first-format pathological image corresponding to the location information and the resolution information in the received request, to cause the responding section to extract the partial image corresponding to the location information in the received request from the stored first-format pathological image based on the location information in the received request, and to cause the responding section to reply the partial image to the terminal.

According to the present application, the controller determines if the storage already stores an image requested from the terminal or not. If the storage stores the image, a partial image is extracted from a pathological image stored in the storage, and the extracted partial image is replied to the terminal. Because of this, a second-format image is not converted. As a result, it is possible to prevent needless conversion processing from being executed.

(6) According to an embodiment of the present application, in the information processing apparatus, the first format may have a selectable image compression rate, the information processing apparatus may further include a dyeing information obtaining section, the dyeing information obtaining section being configured to obtain dyeing information of the first-format pathological image, and the conversion section may be configured to determine an image compression rate used in the conversion based on the obtained dyeing information.

According to the present application, at the end of creating a second-format image, the image is divided into tiles. An image of each tile is compressed. At this time, the compression rate of image compression is determined based on dyeing information. Based on the dyeing information, it is possible to determine if high image quality (low compression rate) is required for the pathological image or low image quality (high compression rate) is allowed for the image. The compression rate is changed based on the dyeing information. As a result, an image, for which high image quality is not required, may be compressed at a high compression rate. As a result, storage consumption may be optimized.

(7) According to an embodiment of the present application, in the information processing apparatus, the storage may be configured to store a plurality of first-format pathological images, and the information processing apparatus may further include an optimization section, the optimization section being configured to calculate reply frequency of each of the plurality of first-format pathological images to the terminal, and to delete a layer of image having the highest resolution out of images in each of the plurality of first-format pathological images stored in the storage in ascending order from a first-format pathological image having the calculated lowest frequency for a predetermined threshold number of first-format pathological images.

According to the present application, a layer of image having the largest data (i.e., highest resolution) is deleted from a pathological image, of which use frequency is low. As a result, the disk space may not be cluttered with image data of a pathological image, of which frequency of reply to the terminal is low (i.e., low use frequency). The disk space may be increased by deleting the layer of image having the largest data. The deleted image may be newly created again based on a second-format pathological image. Because of this, it would not matter if the image is deleted.

(8) According to an embodiment of the present application, in the information processing apparatus, the optimization section may be configured to calculate the reply frequency of the plurality of pathological images stored in the storage, and in a case where the layer of image having the highest resolution is deleted, to cause the obtaining section and the conversion section to create an image having a resolution same as the resolution of the deleted image in descending order from a pathological image having the calculated highest frequency for a predetermined threshold number of pathological images, and to store the created image in the storage.

According to the present application, an image having the highest resolution is deleted from a pathological image, of which use frequency is low. Disk space is thus increased. After that, a high-resolution image of a pathological image, of which frequency of reply to the terminal is high (i.e., high use frequency), is preliminarily created. As a result, in a case where the terminal requests for a high-resolution image, it is possible to reply the image in response to the request in a short time.

(9) According to an embodiment of the present application, in the information processing apparatus, the request may include a user identifier, the user identifier identifying a user of the terminal, and the information processing apparatus may further include a determining section, the determining section being configured to count frequency of specifying a resolution for each user based on the user identifier and the resolution information in the request, and to determine a layer to be converted after conversion of a layer having the lowest resolution for each user based on the counted frequency of specifying resolution for each user.

According to the present application, frequency of specifying resolution is counted for each user. The information processing apparatus previously determines resolution of an image, which is to be specified by a specific user. Further, in a case where a user requests for a pathological image, the information processing apparatus determines resolution of an image, which is converted after converting an image having the lowest resolution, based on the previously-determined frequency of specifying resolution for each user. Here, the image having the lowest resolution is surely converted. As a result, it is possible to prevent needless conversion of an image, of which resolution may not be specified by a specific user, from being executed.

(10) According to an embodiment of the present application, there is provided an information processing method, including: receiving, by a receiving section, a request for a partial image from a terminal, the partial image being at least a part of a first-format pathological image, the first-format pathological image including a plurality of layers of first images having different resolutions, the terminal being capable of displaying the first-format pathological image; obtaining, by an obtaining section, a layer of second-format pathological image having a resolution corresponding to the received request, the second format being different from the first format; converting, by a conversion section, the obtained layer of second-format pathological image into a first-format pathological image having a corresponding resolution; storing, in storage, the converted first-format pathological image; and extracting, by a responding section, the partial image corresponding to the received request from the stored first-format pathological image in response to the received request, and replying the partial image to the terminal.

(11) According to an embodiment of the present application, there is provided an information processing program, causing a computer to function as: a receiving section configured to receive a request for a partial image from a terminal, the partial image being at least a part of a first-format pathological image, the first-format pathological image including a plurality of layers of first images having different resolutions, the terminal being capable of displaying the first-format pathological image; an obtaining section configured to obtain a layer of second-format pathological image having a resolution corresponding to the received request, the second format being different from the first format; a conversion section configured to convert the obtained layer of second-format pathological image into a first-format pathological image having a corresponding resolution; storage configured to store the converted first-format pathological image; and a responding section configured to extract the partial image corresponding to the received request from the stored first-format pathological image in response to the received request, and to reply the partial image to the terminal.

As described above, according to the present application, format conversion of an image may be optimized.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a diagram showing a typical usage environment of an image management server 400 of the present application;

FIG. 2 is a diagram schematically showing an example of a plurality of pathological images forming an image pyramid structure;

FIG. 3 is a diagram for explaining a typical procedure of creating an image group of the image pyramid structure 900;

FIG. 4 is a diagram showing how a status changes;

FIG. 5 is a block diagram showing the hardware configuration of the image management server 400 of the present application;

FIG. 6 is a diagram showing the functional blocks of the image management server 400;

FIG. 7 is a diagram showing the functional blocks of a viewer computer 500;

FIG. 8 is a diagram showing a case where the image management server 400 reproduces the folder structure of a different-company's-format image server 600 as it is;

FIG. 9 is a flowchart for explaining how a data conversion section 45 of the image management server 400 converts a different-company's-format pathological image;

FIG. 10 is a flowchart for explaining how to inquire about the conversion status of a different-company's-format pathological image;

FIG. 11 is a diagram showing examples of a URI, which the viewer computer 500 uses when the viewer computer 500 accesses a pathological image that the image management server 400 stores;

FIG. 12 is a sequence diagram for explaining the overall flow including communication about conversion of a different-company's-format pathological image between the viewer computer 500 and the image management server 400;

FIG. 13 is a flowchart for explaining how to prevent disk space from being wasted;

FIG. 14 is a flowchart for explaining how to increase the processing speed when a high-resolution image is browsed;

FIG. 15 is a flowchart for explaining how to change image quality of image compression based on dyeing information; and

FIG. 16 is a flowchart for explaining how to change definition of a middle-resolution image for each user.

### DETAILED DESCRIPTION

Hereinafter, an embodiment of the present disclosure will be described with reference to the drawings.

### First Embodiment

[Usage Environment of Image Management Server]

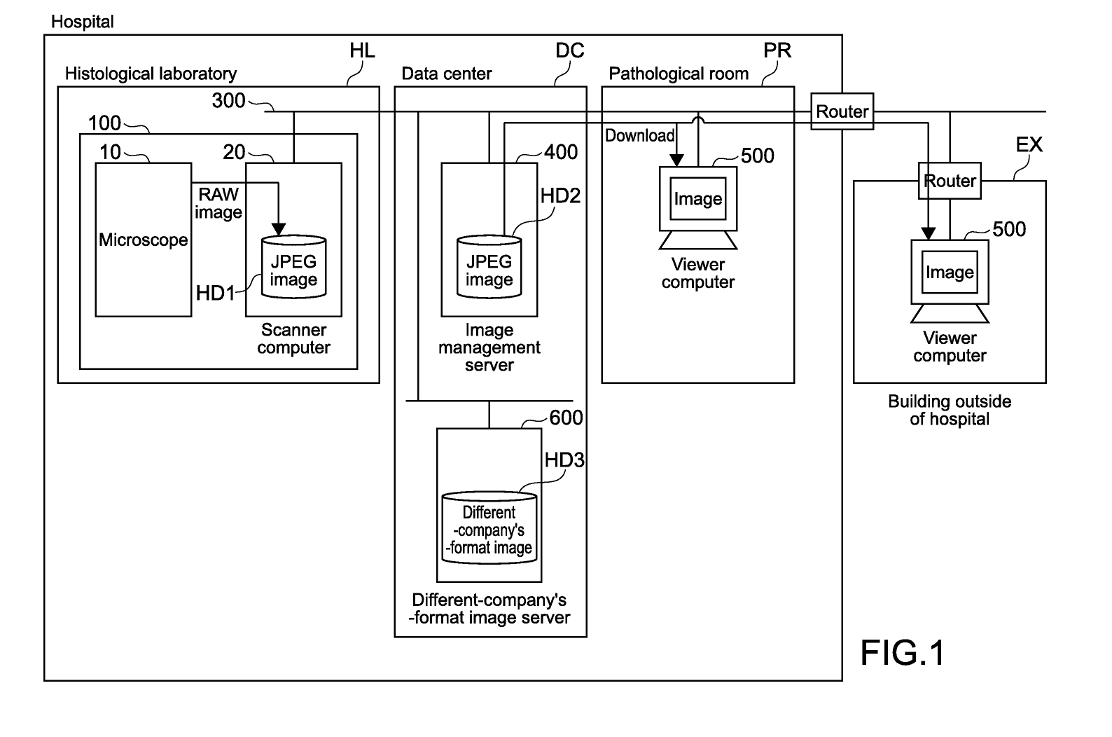

First, the whole picture of an environment of pathology, in which a pathologist makes a diagnosis by using a virtual slide image (pathological image), will be described. The virtual slide image (pathological image) is obtained by taking a picture of a specimen by using a microscope. A pathologist uses a viewer of a viewer computer, observes a pathological image, and makes a diagnosis by using the image. FIG. 1 is a diagram showing a typical usage environment of an image management server 400 of the present application.

A scanner 100 includes a microscope 10 and a scanner computer 20. The scanner 100 is installed in a histological laboratory HL in a hospital. The microscope 10 takes a RAW image. The scanner computer 20 processes the RAW image. Examples of the image processing include processing procedure, shading processing, color balance correction, gamma correction, and 8-bit processing. After that, the processed image is divided into tiles. The size of the tiles is, for example 256 pixels×256 pixels. The image divided into tiles is converted into a JPEG (Joint Photographic Experts Group) image, and is compressed. After that, the compressed image is stored in a hard disk HD1.

The hard disk HD1 of the scanner computer 20 stores the JPEG image. Next, the JPEG image is uploaded to a hard disk HD2 via a network 300. The hard disk HD2 is in the image management server 400. The image management server 400 is in a data center DC in the same hospital.

A pathologist as an observer is in a pathological room PR in the hospital or in a building EX outside of the hospital. The pathologist observes a JPEG image stored in the hard disk HD2 of the image management server 400 by using the viewer computer 500. The viewer computer 500 is connected to the image management server 400 via the network 300.

Alternatively, a pathologist as an observer instructs the viewer computer 500 to record display history. The display history shows how a JPEG image displayed on a viewer window is changed based on an operation, which the pathologist inputs when he observes a JPEG image. The recorded display history is sent to the image management server 400 via the network 300. The image management server 400 stores the display history.

Further, a pathologist instructs the viewer computer 500 to call display history stored in the image management server 400. The viewer is capable of reproducing how a JPEG image was observed.

A different-company's-format image server 600 is installed in the data center DC. The different-company's-format image server 600 stores pathological images (hereinafter referred to as different-company's-format pathological images.), which are taken by a different company's scanner. The format of the pathological images stored in the different-company's-format image server 600 is different from the format of a pathological image, which is taken by the scanner 100. Because of this, the pathological image stored in the different-company's-format image server 600 may not be stored in the hard disk HD2 of the image management server 400 as it is, and may not be observed by using the viewer of the viewer computer 500.

The image management server 400 mounts a folder (directory) of the different-company's-format image server 600 via the network 300. Different-company's-format pathological images are stored in the folder (directory). As a result, the image management server 400 is capable of accessing the different-company's-format pathological images, and accessing the folder structure.

The image management server 400 converts a different-company's-format pathological image into an own-company's format. The image management server 400 stores the converted pathological image in the hard disk HD2. How to observe the image stored in the hard disk HD2 by using the viewer computer 500 is similar to the way to observe an own-company's-format pathological image.

[Image Pyramid Structure]

Next, an image pyramid structure will be described. The image pyramid structure is used as the own company's format and the different company's format. Note that the image pyramid structure of the own-company's format may be referred to as a mipmap structure.

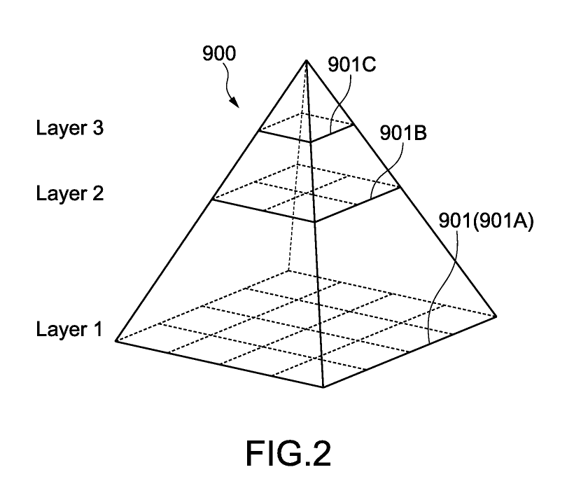

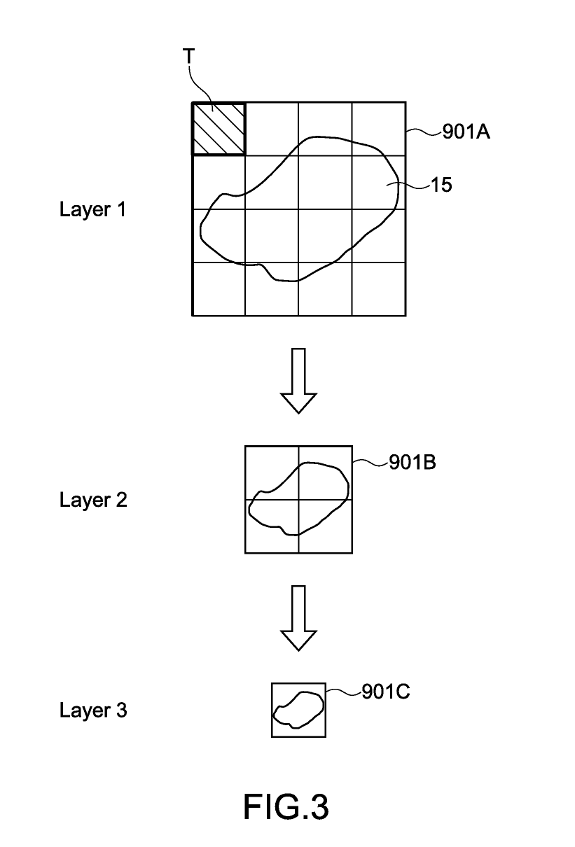

FIG. 2 is a diagram schematically showing an example of a plurality of pathological images forming an image pyramid structure. An image pyramid structure 900 is an image group of one pathological image 901 at a plurality of different resolutions. The microscope 10 takes a picture of one object 15 (see FIG. 3) to thereby obtain the pathological image 901 at the plurality of different resolutions.

A pathological image 901A having the largest size is at the lowermost layer of the image pyramid structure 900. A pathological image 901C having the smallest size is at the uppermost layer of the image pyramid structure 900.

In the example of FIG. 2, the image pyramid structure 900 includes three layers. A layer index value is set as information showing a layer. In this embodiment, the lowermost layer is a layer 1, i.e., the layer index value. The pathological image 901A having the largest size is at the lowermost layer. As shown in FIG. 2, a layer index value increases from the lowermost layer as resolution decreases. That is, the layer index value of the pathological image 901C having the lowest resolution is a layer 3.

In this embodiment, a pathological image at the layer 1 is referred to as a high-resolution image. A pathological image at a layer 2 is referred to as a middle-resolution image. A pathological image at the layer 3 is referred to as a thumbnail image.

[How to Create Image Pyramid Structure (in Case of Own Company Scanner)]

FIG. 3 is a diagram for explaining a typical procedure of creating an image group of the image pyramid structure 900. Note that the procedure is used in a case of creating the image pyramid structure 900 of the own-company's format. Let's say that the image pyramid structure 900 is created based on a different-company's-format pathological image. In this case, a different-company's-format pathological image having a resolution corresponding to each layer is converted. As a result, the image pyramid structure 900 is created.

The microscope 10 obtains an original image at predetermined observe magnification. First, a digital image of the original image is prepared. The original image is the pathological image 901A having the largest size, i.e., the image at the lowermost layer of the image pyramid structure 900. That is, the original image is a pathological image having the highest resolution. In view of this, an image observed and obtained at a relatively high magnification by an optical microscope is used as an image at the lowermost layer of the image pyramid structure 900.

Note that, in the field of pathology, generally, a slice thinly cut off from a living internal organ, a biological tissue, a cell, or a part of any one of these is an observation object 15. Then, the scanner 100 reads out the object 15 held in a glass slide. The scanner computer 20 or the image management server 400 stores an obtained digital image.

As shown in FIG. 3, the scanner computer 20 or the image management server 400 creates a plurality of pathological images 901B and 901C (layers 2 and 3) based on the thus-obtained pathological image having the largest size. The pathological images 901B and 901C respectively have resolutions lowered step by step. The scanner computer 20 or the image management server 400 stores these images every “tile” unit, for example. The “tile” is a unit of a predetermined size. The size of one tile T is, for example, 256×256 pixels or 512×512 pixels.

[How to create image pyramid structure (in case of converting different-company's-format image)]

Let's say that the image pyramid structure 900 is created based on a different-company's-format pathological image. In this case, as described above, a different-company's-format pathological image having a corresponding resolution is converted, to thereby create a pathological image of the corresponding layer. A different-company's-format pathological image may be up-converted or down-converted. As a result, a pathological image, which has a resolution different from the resolution of a different-company's-format pathological image, may be created. In view of this, the number of layers of a different-company's-format pathological image before conversion is not necessarily the same as the number of layers of an own-company's-format pathological image after conversion. The number of layers of a different-company's-format pathological image before conversion may be different from the number of layers of an own-company's-format pathological image after conversion. Note that at least an image encoding scheme is converted.

First, a thumbnail image is converted. A middle-resolution image is converted as necessary. Further, a high-resolution image is converted as necessary. The image pyramid structure 900 has four statuses, i.e., an initial status, a thumbnail image status, a middle-resolution image status, and a high-resolution image status.

In the initial status, the image pyramid structure 900 has no image. In the thumbnail image status, the image pyramid structure 900 only has a thumbnail image. In the middle-resolution image status, the image pyramid structure 900 has the thumbnail image and a middle-resolution image. In the high-resolution image status, the image pyramid structure 900 has the thumbnail image, the middle-resolution image, and a high-resolution image.

[How Status of Image Pyramid Structure Changes]

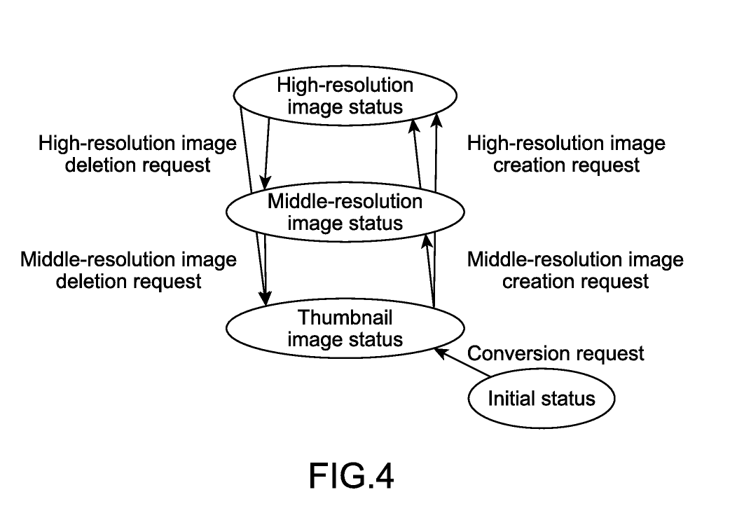

Let's say that the image pyramid structure 900 is created based on a different-company's-format pathological image. In this case, the status of the image pyramid structure 900 changes between four statuses, i.e., the initial status, the thumbnail image status, the middle-resolution image status, and the high-resolution image status. FIG. 4 is a diagram showing how the status changes.

First, the image pyramid structure 900 is in the initial status. Then, the viewer computer 500 sends a conversion request. Then, the image management server 400 converts a thumbnail image out of different-company's-format pathological images. As a result, the image pyramid structure 900 includes a thumbnail image. Then, the status of the image pyramid structure 900 changes from the initial status to the thumbnail image status.

Similarly, the viewer computer 500 sends a middle-resolution image creation request. Then, the image management server 400 creates a middle-resolution image. As a result, the status of the image pyramid structure 900 changes to the middle-resolution image status. Further, the viewer computer 500 sends a high-resolution image creation request. Then, the image management server 400 creates a high-resolution image. As a result, the status of the image pyramid structure 900 changes to the high-resolution image status.

Further, let's say that the image pyramid structure 900 is in the high-resolution image status. In this case, the image management server 400 generates a high-resolution image deletion request. The image management server 400 deletes a high-resolution image. In this case, the status of the image pyramid structure 900 changes to the middle-resolution image status. Further, let's say that the image pyramid structure 900 is in the middle-resolution image status. In this case, the image management server 400 generates a middle-resolution image deletion request. The image management server 400 deletes a middle-resolution image. In this case, the status of the image pyramid structure 900 changes to the thumbnail image status.

How the status of the image pyramid structure 900 changes in a case of creating the image pyramid structure 900 based on a different-company's-format pathological image has been described above.

[Outline of Present Application]

Next, the outline of the present application will be described. In the related art, a pyramid structure of a different-company's format is converted into a pyramid structure of an own-company's format. As a result, a pathological image, which is taken by a scanner of the different company, is observed by using the viewer computer 500. All the layers in the pyramid structure are converted all at once. Because of this, it takes a lot of time to convert the pyramid structure. Further, the converted pathological image takes up a lot of disk space when the converted pathological image is stored.

In view of the above-mentioned circumstances, according to the present application, all the layers are not converted all at once. Instead, a necessary layer is converted every time a request from the viewer computer 500 is received. As a result, the conversion time of the present application may be shorter than the conversion time of the case where all the layers are converted all at once. Further, the hard disk space of the present application may be smaller than the hard disk space of the case where all the layers are converted all at once, in a case of storing converted pathological images.

[Configuration of Image Management Server 400]

Next, the hardware configuration of the image management server 400 will be described.

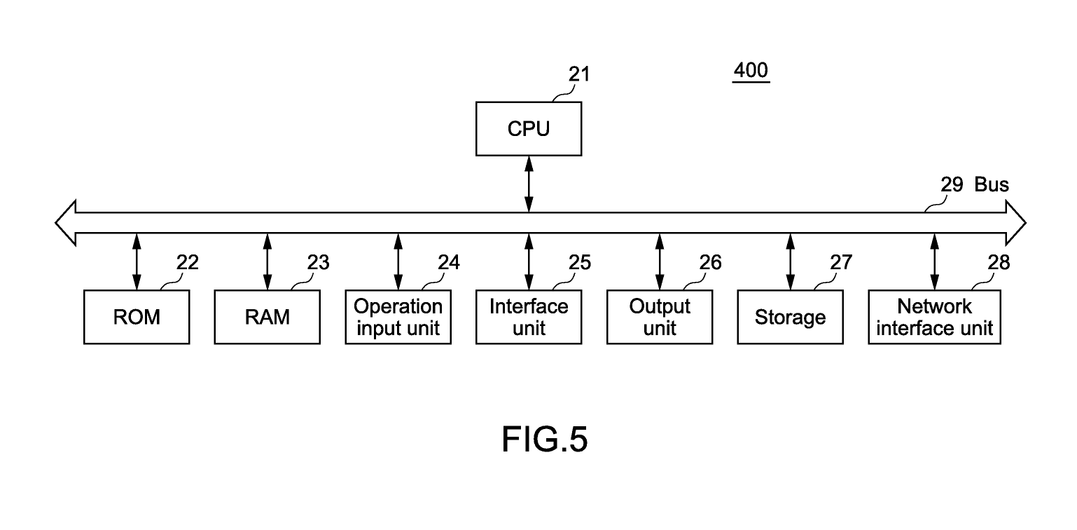

FIG. 5 is a block diagram showing the hardware configuration of the image management server 400 of the present application.

The image management server 400 includes a CPU (Central Processing Unit) 21, a ROM (Read Only Memory) 22, a RAM (Random Access Memory) 23, and an operation input unit 24. The CPU 21 performs arithmetic control. The RAM 23 is a work memory for the CPU 21. Instructions depending on operation by a user are input in the operation input unit 24. The image management server 400 further includes an interface unit 25, an output unit 26, storage 27, a network interface unit 28, and a bus 29 connecting them.

Programs for executing various processes are stored in the ROM 22. The network 300 is connected to the network interface unit 28. The output unit 26 is a liquid crystal display, an EL (Electro Luminescence) display, a plasma display, or the like. The storage 27 is a magnetic disk such as an HDD (Hard Disk Drive), a semiconductor memory, an optical disk, or the like.

The CPU 21 expands a program corresponding to an instruction from the operation input unit 24, out of a plurality of programs stored in the ROM 22, the storage 27, and the like, in the RAM 23. The CPU 21 arbitrarily controls the output unit 26 and the storage 27 based on the expanded program.

The CPU 21 implements functional blocks (described later). The CPU 21 executes the programs stored in the ROM 22, the storage 27, and the like. The CPU 21 as necessary controls the above-mentioned units. Because of this, the image management server 400 is capable of implementing the various functional blocks. The image management server 400 is capable of causing the respective unit to function as the image management server 400.

[Configuration of Viewer Computer 500]

Next, the hardware configuration of the viewer computer 500 will be described.

The hardware configuration of the viewer computer 500 is basically the same as the hardware configuration of the image management server 400. In view of this, detailed description of the hardware configuration of the viewer computer 500 is omitted.

[Configuration of Different-Company's-Format Image Server 600]

Next, the hardware configuration of the different-company's-format image server 600 will be described.

The different-company's-format image server 600 has any hardware configuration as long as the different-company's-format image server 600 is configured to mount a folder (directory), in which different-company's-format pathological images are stored, on the image management server 400, and to offer a service in which the image management server 400 may read data in the folder.

[Functional Blocks of Image Management Server 400]

Next, the functional blocks of the image management server 400 will be described. The first main function of the image management server 400 is to provide a pathological image in response to a request from the viewer computer 500. The second main function of the image management server 400 is to store display history obtained from the viewer computer 500, and to provide the display history in response to a request from the viewer computer 500.

The third main function of the image management server 400 is to access the different-company's-format image server 600 in response to a different-company's-format pathological image browse request from the viewer computer 500, and to convert the format of a pathological image to thereby create a pathological image having a necessary resolution.

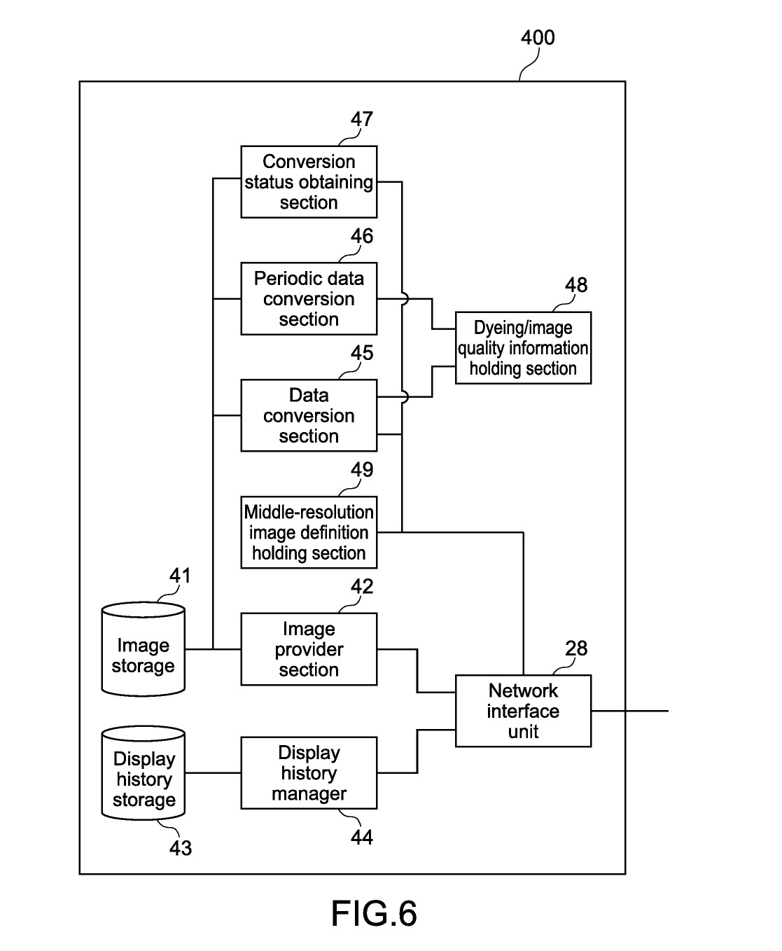

FIG. 6 is a diagram showing the functional blocks of the image management server 400.

The image management server 400 includes the following functional blocks, i.e., image storage 41 (storage), an image provider section 42 (receiving section, responding section, controller), display history storage 43, a display history manager 44, a data conversion section 45 (obtaining section, conversion section), a periodic data conversion section 46 (optimization section), a conversion status obtaining section 47, a dyeing/image quality information holding section 48 (dyeing information obtaining section), and a middle-resolution image definition holding section 49 (determining section).

The image storage 41 stores a pathological image, which is divided into tiles and compressed in the JPEG format. The image provider section 42 provides the stored pathological image to the viewer computer 500 in response to a request from the viewer computer 500. The image storage 41 also stores a pathological image, which is converted from a pathological image of the different-company's format.

The viewer computer 500 sends an image request via the network 300. The image provider section 42 obtains a pathological image appropriate to the image request from the image storage 41. The image provider section 42 sends the pathological image to the viewer computer 500 via the network 300. The image request may specify a location and a resolution to thereby determine a requested image. Alternatively, the image request may specify the numbers of the above-mentioned tiles to thereby determine a requested image. Let's say that the viewer computer 500 sends an image request for a different-company's-format pathological image. In this case, the image provider section 42 instructs the data conversion section 45 to convert a pathological image, which is stored in the different-company's-format image server 600.

The display history storage 43 stores display history of the viewer, which is operated by a user by using the viewer computer 500.

The viewer computer 500 records and collects display history once. The display history manager 44 obtains the display history via the network 300. Further, the display history manager 44 stores the obtained display history in the display history storage 43. Further, the display history manager 44 receives a display history request from the viewer computer 500. The display history manager 44 obtains display history appropriate to the display history request from the display history storage 43. The display history manager 44 sends the display history to the viewer computer 500 via the network 300.

The viewer computer 500 sends a conversion request. The data conversion section 45 converts a different-company's-format pathological image in response to the conversion request. The data conversion section 45 obtains a different-company's-format pathological image from the different-company's-format image server 600. The data conversion section 45 converts the format of the pathological image. After that, the data conversion section 45 stores the converted pathological image in the image storage 41 based on the image pyramid structure of the own-company's format.

The periodic data conversion section 46 deletes and creates a first-layer pathological image. The first-layer pathological image is in the image pyramid structure 900 of the own-company's format, which is converted from the different-company's-format pathological image. The periodic data conversion section 46 examines browse frequency of converted pathological images. The periodic data conversion section 46 deletes the first layers (i.e., pathological images having largest size) of the preset threshold number of the image pyramid structures 900 in the ascending order from the image pyramid structure 900 having the smallest browse frequency. As a result, disk space is increased.

After that, the periodic data conversion section 46 newly converts the first layers of the preset threshold numbers of the image pyramid structures 900 in the descending order from the image pyramid structure 900 having the largest browse frequency in a case where the image pyramid structure 900 does not have a first-layer pathological image. As a result, the periodic data conversion section 46 creates the first-layer pathological images. The periodic data conversion section 46 executes the above-mentioned processing periodically (for example, once every hour). Note that, in the above description, the periodic data conversion section 46 converts data. Alternatively, the data conversion section 45 may convert data in response to an instruction from the periodic data conversion section 46.

The viewer computer 500 inquires about the conversion status of a specific image pyramid structure 900. Then, the conversion status obtaining section 47 examines which layers of the image pyramid structure 900 are converted. The conversion status obtaining section 47 returns the examination result to the viewer computer 500.

The dyeing/image quality information holding section 48 holds dyeing information (described later) and image quality information, which is used in a case of converting a different-company's-format pathological image based on the dyeing information. The dyeing/image quality information holding section 48 provides the held image quality information to the data conversion section 45 and the periodic data conversion section 46.

The middle-resolution image definition holding section 49 holds information on a layer out of a plurality of layers of the image pyramid structure 900, which is defined as the middle-resolution image. The middle-resolution image definition holding section 49 provides the held definition information of the middle-resolution image to the data conversion section 45. The data conversion section 45 uses the definition information when the data conversion section 45 converts a different-company's-format pathological image.

[Functional Blocks of Viewer Computer 500]

Next, the functional blocks of the viewer computer 500 will be described. The first main function of the viewer computer 500 is to receive an operation instruction from a user being a pathologist, to obtain an appropriate pathological image from the image management server 400, and to display the pathological image for the user.

The second main function of the viewer computer 500 is to record display of an image based on a viewer operation when a user makes a diagnosis based on an image, and to send the display history to the image management server 400 such that the image management server 400 stores the display history. The third main function of the viewer computer 500 is to obtain display history stored in the image management server 400 in response to a request from a user, and to reproduce, for a user, display of an image based on an operation input by a user, based on the display history.

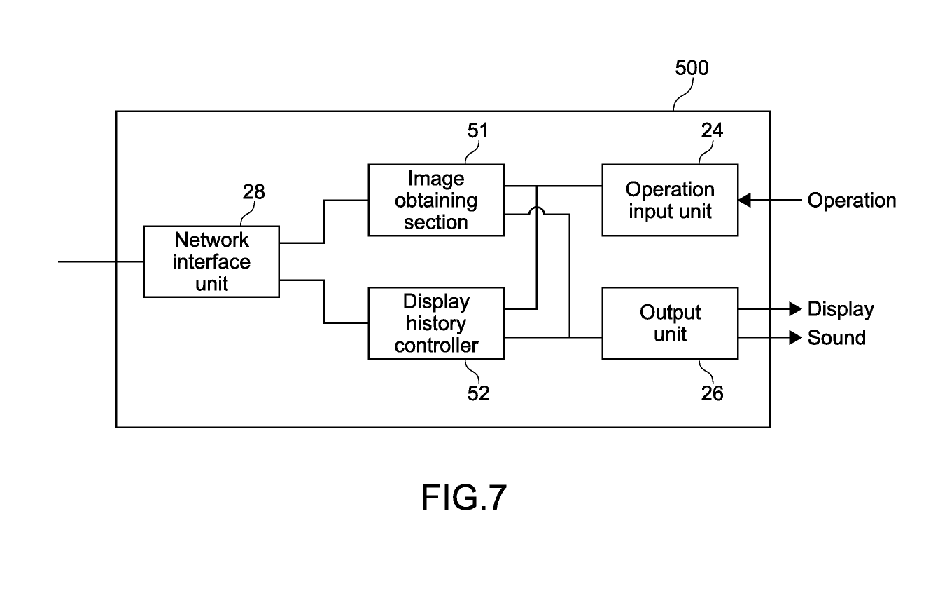

FIG. 7 is a diagram showing the functional blocks of the viewer computer 500.

The viewer computer 500 includes the following functional blocks, i.e., an image obtaining section 51 and a display history controller 52.

The operation input unit 24 inputs an instruction from a user being a pathologist. The image obtaining section 51 obtains a pathological image appropriate to the instruction from the image management server 400 via the network 300. The image obtaining section 51 displays the obtained pathological image on the output unit 26 to thereby present the pathological image to a user.

In response to an instruction from a user, the display history controller 52 records change of screen display based on a viewer operation when a user observes a pathological image. First, the display history controller 52 stores the recorded change of display in the RAM 23 or the storage 27 of the viewer computer 500. In response to a recording stop instruction, the display history controller 52 collects the recorded change of display. The display history controller 52 sends recorded change of display to the image management server 400 as display history. The image management server 400 stores the display history.

Further, in response to an instruction from a user, the display history controller 52 obtains display history appropriate to the instruction from the image management server 400. The display history controller 52 displays the screen display of the viewer, which is recorded in the obtained display history, on the output unit 26, to thereby present the screen display of the viewer to a user.

[Data Conversion (in Case of Converting Thumbnail Image)]

Next, how to convert a different-company's-format pathological image into a thumbnail image of the image pyramid structure 900 will be described.

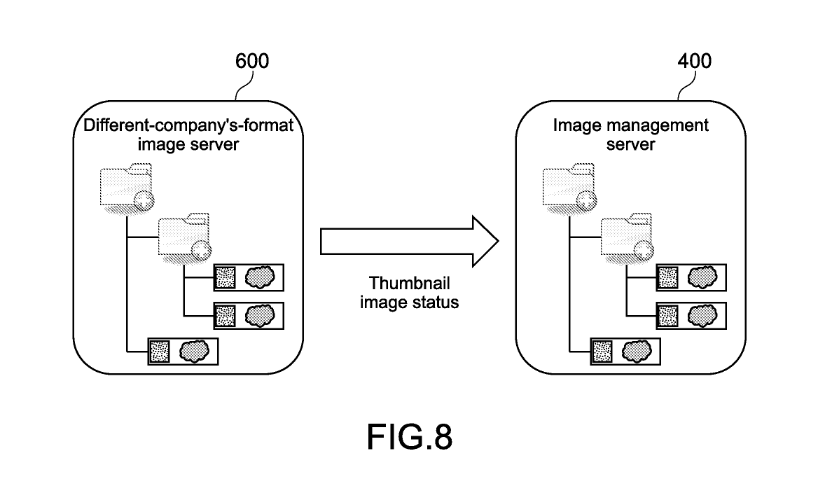

FIG. 8 is a diagram showing a case where the image management server 400 reproduces the folder structure of the different-company's-format image server 600 as it is.

As shown in FIG. 8, a different-company's-format pathological image is converted into a thumbnail image of the image pyramid structure 900. In this case, the image management server 400 reproduces the folder structure as it is. Because of this, if the different-company's-format pathological images are organized based on the folder structure, the image management server 400 may take over the organized status as it is.

[Flow of Data Conversion]

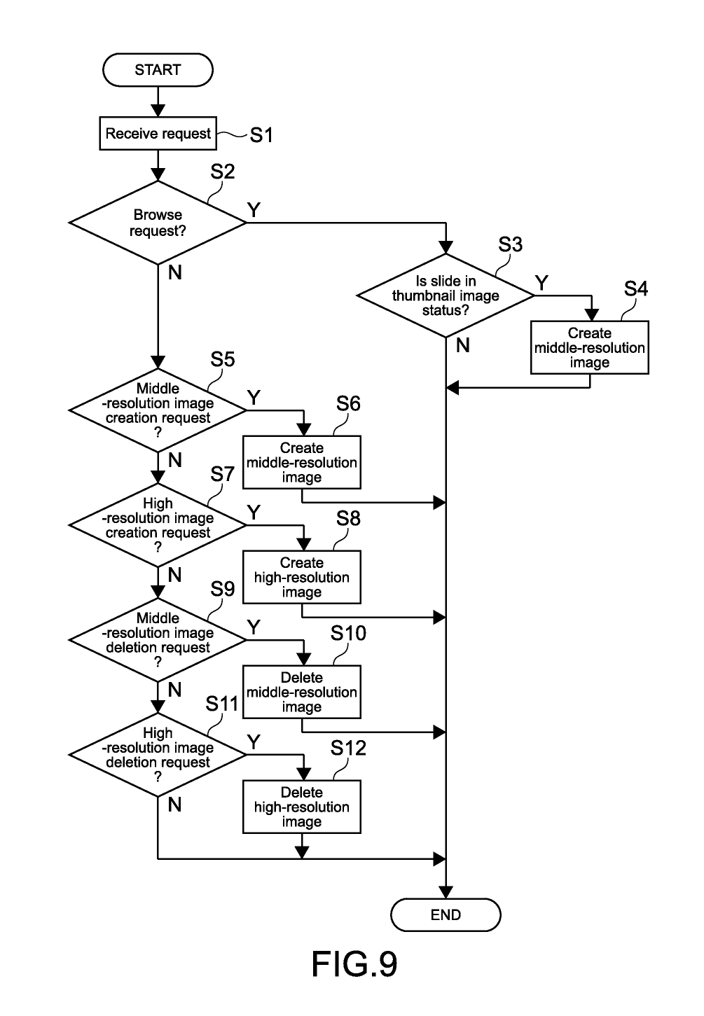

Next, how the data conversion section 45 of the image management server 400 converts a different-company's-format pathological image will be described. FIG. 9 is a flowchart for explaining how the data conversion section 45 of the image management server 400 converts a different-company's-format pathological image.

First, the data conversion section 45 receives a request from the viewer computer 500 (Step S1).

The received request is a browse request (Step S2, Y). In this case, next, the data conversion section 45 determines if the status of the image pyramid structure 900 appropriate to the browse request is the thumbnail image status or not (Step S3). The image pyramid structure 900 is in the thumbnail image status (Step S3, Y). In this case, the data conversion section 45 predicts that the data conversion section 45 will receive a request for a middle-resolution image next. The data conversion section 45 preliminarily creates a middle-resolution image (Step S4).

Similarly, the request received from the viewer computer 500 is a middle-resolution image creation request (Step S5, Y). In this case, the data conversion section 45 converts a pathological image, of which resolution corresponds to the middle resolution, out of different-company's-format pathological images. As a result, the data conversion section 45 creates a middle-resolution image (Step S6). If the request received from the viewer computer 500 is a high-resolution image creation request (Step S7, Y), the data conversion section 45 similarly creates a high-resolution image (Step S8).

Note that the data conversion section 45 receives the middle-resolution image creation request. In this case, the data conversion section 45 confirms if the image storage 41 already stores a middle-resolution image or not before the data conversion section 45 converts a pathological image, of which resolution corresponds to the middle-resolution. If the image storage 41 already stores a middle-resolution image, the data conversion section 45 avoids the trouble of having to newly create a middle-resolution image. The same applies to the high-resolution image creation request.

Further, the request received by the data conversion section 45 is a middle-resolution image deletion request (Step S9, Y). In this case, the data conversion section 45 deletes a middle-resolution image of the appropriate image pyramid structure 900 (Step S10). If the received request is a high-resolution image deletion request (Step S11, Y), the data conversion section 45 similarly deletes a high-resolution image (Step S12).

Similar to the above, the data conversion section 45 receives a middle-resolution image deletion request. Then, the data conversion section 45 confirms if the image storage 41 stores a middle-resolution image or not before the data conversion section 45 deletes a pathological image, of which resolution corresponds to the middle-resolution. If the image storage 41 does not store a middle-resolution image, the data conversion section 45 avoids the trouble of having to delete a middle-resolution image. The same applies to the high-resolution image deletion request.

How the data conversion section 45 converts or deletes a pathological image has been described above.

[How to Inquire about Conversion Status]

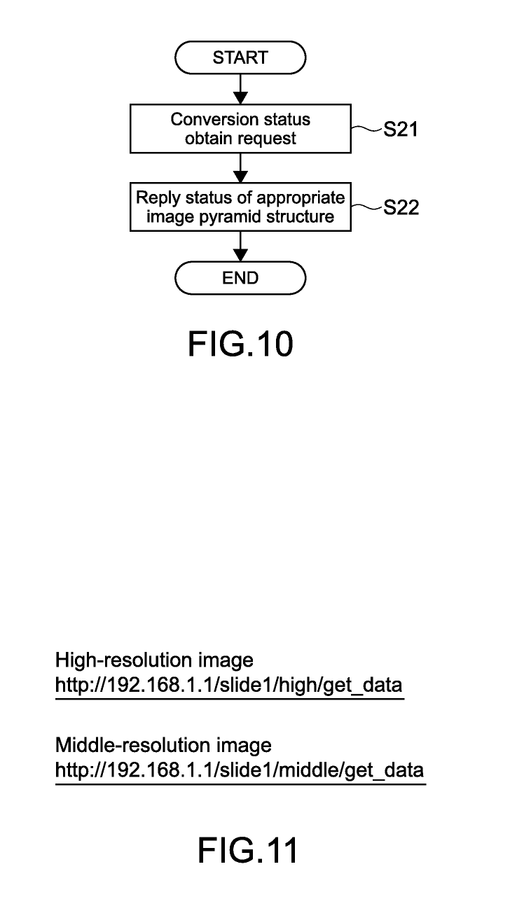

Next, how the viewer computer 500 inquires of the image management server 400 for the conversion status of a different-company's-format pathological image will be described. FIG. 10 is a flowchart for explaining how to inquire about the conversion status of a different-company's-format pathological image.

Note that the viewer computer 500 sends the inquiry mainly in the following situation. The viewer computer 500 has sent a middle-resolution image creation request or a high-resolution image creation request. The viewer computer 500 sends the inquiry in order to confirm if the data conversion section 45 has finished conversion.

First, the viewer computer 500 sends a conversion status obtain request to the conversion status obtaining section 47 of the image management server 400 (Step S21).

Next, the conversion status obtaining section 47 examines the conversion status of the appropriate image pyramid structure 900. The conversion status obtaining section 47 replies the examination result to the viewer computer 500 (Step S22).

For example, the appropriate image pyramid structure 900 is in the thumbnail image status. In this case, the image management server 400 receives a middle-resolution image creation request from the viewer computer 500. The image management server 400 is converting a middle-resolution image. In this case, the conversion status obtaining section 47 replies the thumbnail image status to the viewer computer 500 as the status of the image pyramid structure 900. Then, the image management server 400 has converted a middle-resolution image. In this case, the conversion status obtaining section 47 replies the middle-resolution image status to the viewer computer 500 as the status of the image pyramid structure 900.

How the viewer computer 500 inquires of the image management server 400 for the conversion status of a different-company's-format pathological image has been described above.

[Example of Access URI]

The viewer computer 500 uses a URI (Uniform Resource Identifier) when the viewer computer 500 accesses a pathological image that the image management server 400 stores. Next, examples of the URI will be described. FIG. 11 is a diagram showing examples of a URI, which the viewer computer 500 uses when the viewer computer 500 accesses a pathological image that the image management server 400 stores.

Let's say that the viewer computer 500 obtains a pathological image, i.e., a high-resolution image, from the image management server 400. In this case, as shown in FIG. 11, the viewer computer 500 uses a URI (http://192.168.1.1/slide1/high/get_data) dedicated to obtaining a high-resolution image. Let's say that the viewer computer 500 obtains a middle-resolution image. Similarly, in this case, the viewer computer 500 uses a URI dedicated to obtaining a middle-resolution image.

[Overall Flow]

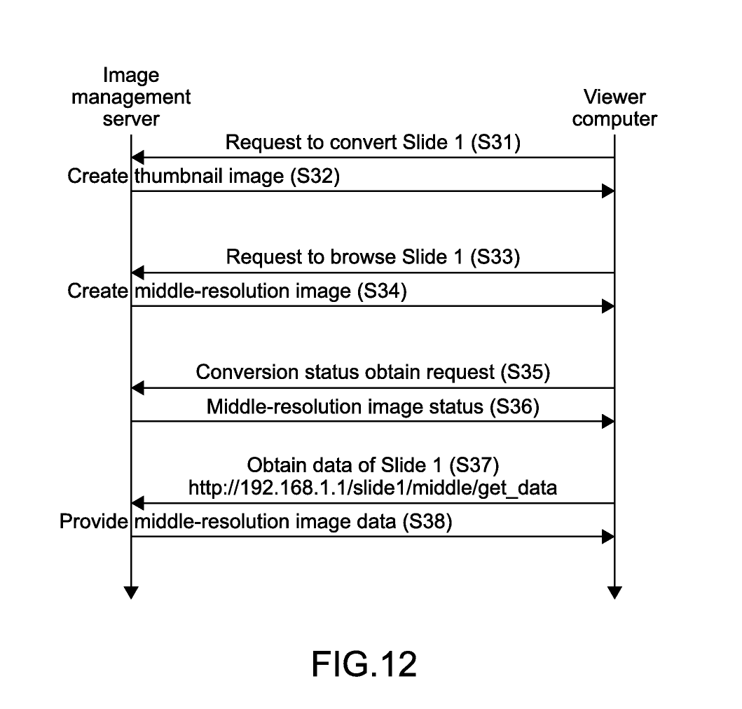

Next, the overall flow will be described. The overall flow includes communication about conversion of a different-company's-format pathological image between the viewer computer 500 and the image management server 400. FIG. 12 is a sequence diagram for explaining the overall flow including communication about conversion of a different-company's-format pathological image between the viewer computer 500 and the image management server 400.

First, the viewer computer 500 sends a request to convert a slide 1 to the image management server 400 (S31). The slide 1 is the name of a different-company's-format pathological image, which a user wishes to observe.

The data conversion section 45 of the image management server 400 receives the request to convert the slide 1. If the image management server 400 does not store a thumbnail image, next, the data conversion section 45 creates a thumbnail image (S32). As described above, a folder of the different-company's-format image server 600 is mounted on the image management server 400. The data conversion section 45 reads the folder. The data conversion section 45 converts a thumbnail image. As a result, the data conversion section 45 creates a thumbnail image. The data conversion section 45 sends the created thumbnail image to the viewer computer 500. Because of this, a user may determine if a pathological image to be converted is a pathological image, which the user wishes to observe in detail, or not.

The user watches the thumbnail image, and confirms what is in the thumbnail image. The user operates the viewer computer 500, and the viewer computer 500 sends a request to browse the slide 1 to the image management server 400 (S33). In response to the browse request, if the image management server 400 does not store a middle-resolution image yet, the data conversion section 45 of the image management server 400 creates a middle-resolution image (S34).

It takes time to create a middle-resolution image. Because of this, the viewer computer 500 periodically sends a conversion status obtain request to the conversion status obtaining section 47 of the image management server 400 (S35). The data conversion section 45 has created a middle-resolution image. Then, the conversion status obtaining section 47 returns the middle-resolution image status in response to a conversion status obtain request from the viewer computer 500 (S36).

The viewer computer 500 receives the returned middle-resolution image status, and determines that a middle-resolution image has been created based on the middle-resolution image status. Then, the viewer computer 500 accesses the image management server 400 by using a URI dedicated to obtaining a middle-resolution image (S37). In response to the access from the viewer computer 500, the image provider section 42 of the image management server 400 provides the middle-resolution image to the viewer computer 500 (S38).

The main flow of the communication between the viewer computer 500 and the image management server 400 has been described above.

[How to Periodically Convert Data]

Next, how to periodically convert data will be described. Note that the description will be made on the basis that image data of the image pyramid structure 900 (slide) is stored in a hard disk drive. Further, to execute something periodically means to execute something once every hour or the like, for example.

Data is converted periodically in order to prevent disk space from being wasted and in order to increase the processing speed when a high-resolution image is browsed. First, processing for preventing disk space from being wasted is executed. As a result, disk space of the hard disk drive is increased. Then, the processing speed when a high-resolution image is browsed is increased depending on the disk space.

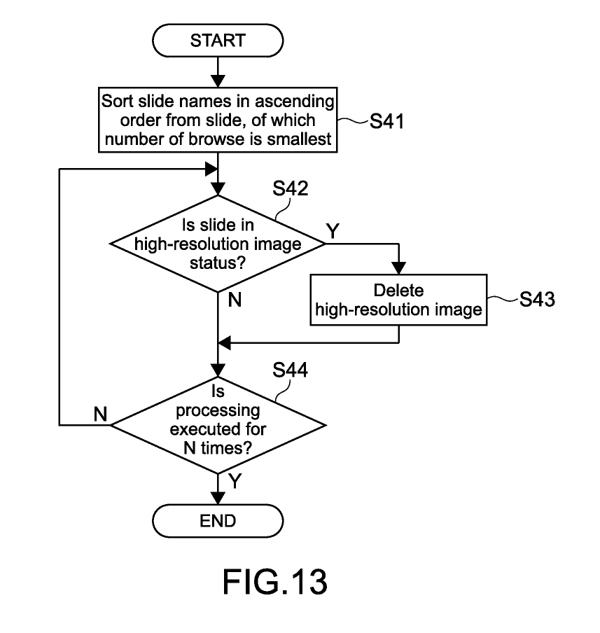

First, how to prevent disk space from being wasted will be described. FIG. 13 is a flowchart for explaining how to prevent disk space from being wasted.

First, the periodic data conversion section 46 sorts the image pyramid structures 900 (hereinafter, referred to as slides), which are converted from different-company's-format pathological images, out of pathological images stored in the image storage 41. Specifically, the periodic data conversion section 46 sorts the slides in the ascending order from the slide, of which number of browse is the smallest (Step S41).

For example, the slide 1 is used for observation ten times. The slide 2 is used for observation once. The slide 3 is used for observation 1000 times.

Next, the periodic data conversion section 46 examines if each slide is in the high-resolution image status in the order of sort (Step S42). In other words, the periodic data conversion section 46 examines if each slide includes a high-resolution image. Such a high-resolution image takes up the largest disk space. An appropriate slide is in the high-resolution image status (Step S42, Y). In this case, the periodic data conversion section 46 deletes a high-resolution image in the slide (Step S43).

The above-mentioned processing is executed in the order of the slide 2, the slide 1, and the slide 3. Note that the processing is executed for a preset threshold number (N) of slides. If the threshold is 2, a high-resolution image of the slide 3 is not deleted (Step S44).

How to prevent disk space from being wasted has been described above.

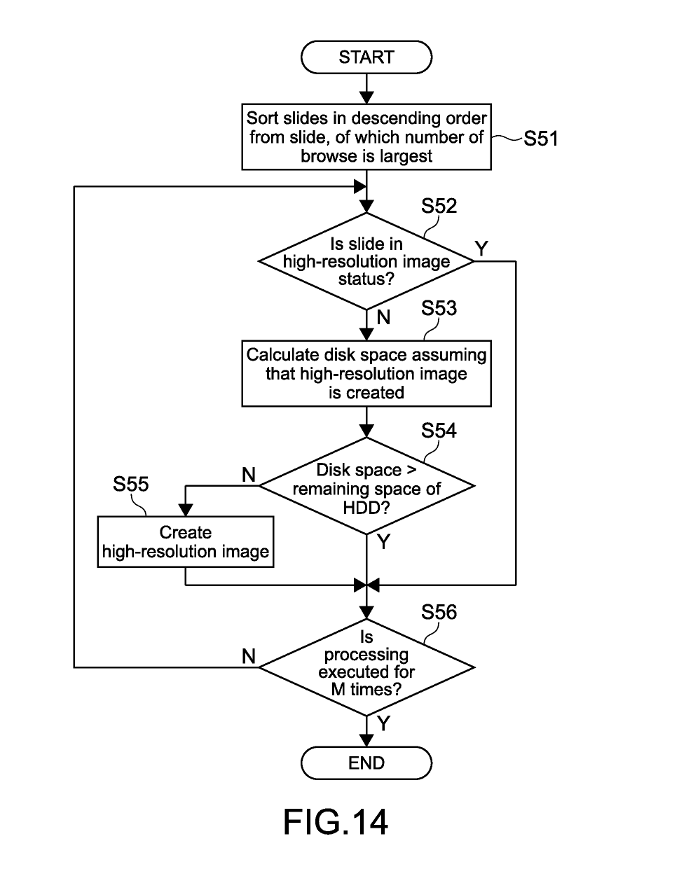

Next, how to increase the processing speed when a high-resolution image is browsed will be described. Note that a high-resolution image is preliminarily prepared, to thereby increase the processing speed when a high-resolution image is browsed. FIG. 14 is a flowchart for explaining how to increase the processing speed when a high-resolution image is browsed.

First, the periodic data conversion section 46 sorts the slides, which are converted from different-company's-format pathological images, out of pathological images stored in the image storage 41. Specifically, the periodic data conversion section 46 sorts the slides in the descending order from the slide, of which number of browse is the largest (Step S51).

Next, the periodic data conversion section 46 examines if each slide is in the high-resolution image status in the order of sort (Step S52). An appropriate slide is in the high-resolution image status (Step S52, Y). In this case, it is not necessary to newly create a high-resolution image of the slide. That is, the periodic data conversion section 46 executes nothing.

An appropriate slide is not in the high-resolution image status (Step S52, N). In this case, next, the periodic data conversion section 46 calculates disk space assuming that a high-resolution image of the slide is created (Step S53).

Next, the periodic data conversion section 46 examines if the calculated disk space is smaller than the remaining space of the disk (Step S54). If the disk space is smaller than the remaining space of the disk (Step S54, N), the periodic data conversion section 46 creates a high-resolution image of the appropriate slide (Step S55).

The above-mentioned processing is executed in the order of the slide 3, the slide 1, and the slide 2. Note that the processing is executed for a preset threshold number (M) of slides. If the threshold is 2, a high-resolution image of the slide 2 is not created (Step S56).

How to increase the processing speed when a high-resolution image is browsed has been described above.

[How to Adjust Conversion Image Quality Based on Dyeing Information]

Next, how to adjust conversion image quality based on dyeing information will be described. The dyeing information is metadata of a different-company's-format pathological image, and is information on dyeing of the object 15. Further, to adjust a conversion image quality is to adjust a compression rate of image compression in a case where a different-company's-format pathological image is converted into the own-company's format and then the converted image is compressed finally. By adjusting the compression rate, an image to be stored is selected from an image having a high image quality and an image having a low image quality.

For example, in a case of dyeing a cell membrane, only a limited area, i.e., a cell membrane, is dyed. It is necessary to prepare an image having a high image quality to observe the area. Meanwhile, for example, in a case of dyeing the entire cell, the entire cell is dyed. So the area to be observed is larger. A user may observe the area in an image having a low image quality.

For example, the image quality of the slide 1 is 0.5 bpp (bits per pixel). The image quality of the slide 2 is 1 bpp. The image quality of the slide 3 is 0.7 bpp. In this manner, the image quality may be adjusted. The optimum image quality may be selected. As a result, hard disk utilization may also be optimized. Note that, here, 1 bpp means 1/24 image compression approximately.

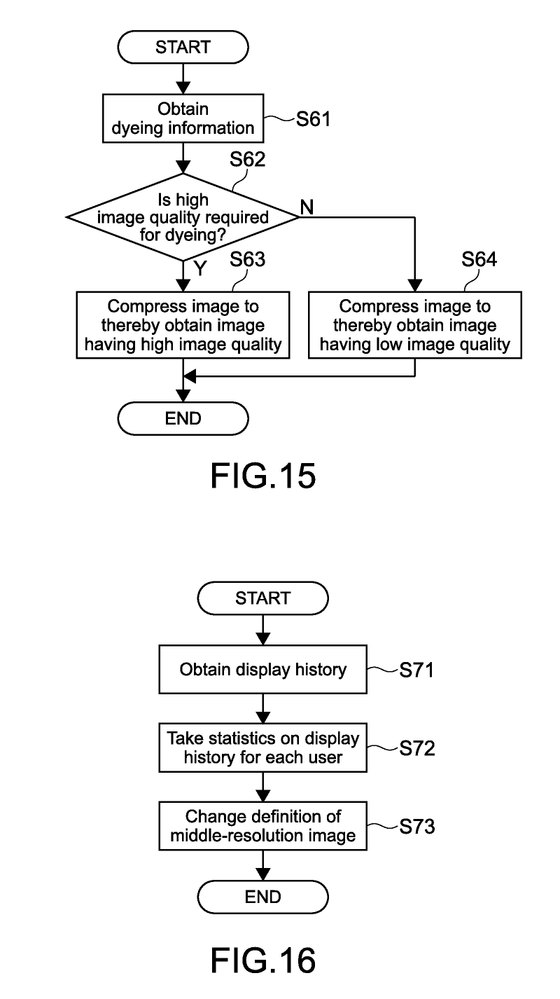

Next, how to change image quality of image compression based on dyeing information will be described. FIG. 15 is a flowchart for explaining how to change image quality of image compression based on dyeing information.

First, the dyeing/image quality information holding section 48 obtains dyeing information from metadata of a specific different-company's-format pathological image to be converted (Step S61).

Next, the data conversion section 45 (in case of data conversion in response to request from viewer computer 500) or the periodic data conversion section 46 (in case of periodic data conversion) converts a different-company's-format pathological image into the own-company's format. In this case, the data conversion section 45 or the periodic data conversion section 46 compresses the image at the end of conversion. At this time, the data conversion section 45 or the periodic data conversion section 46 determines if a high image quality is required or not (Step S62).

It is determined that a high image quality is necessary (Step S62, Y). In this case, the data conversion section 45 or the periodic data conversion section 46 compresses the image to thereby obtain an image having a high image quality (low compression) (Step S63). It is determined that a high image quality is not necessary (Step S62, N). In this case, the data conversion section 45 or the periodic data conversion section 46 compresses the image to thereby obtain an image having a low image quality (high compression) (Step S64).

How to change the image quality of image compression based on dyeing information has been described above.

[How to Change Definition of Middle-Resolution Image]

In the above description, for ease of explanation, the image pyramid structure 900 has three layers, i.e., the thumbnail image, the middle-resolution image, and the high-resolution image in the ascending order from a pathological image having the lowest resolution. In fact, a typical image pyramid structure has five to ten layers. In this case, a pathological image having the lowest resolution at the uppermost layer is the thumbnail image. A pathological image having the highest resolution at the lowermost layer is the high-resolution image. They are the same as the above description. However, definition of a middle-resolution image is different from the above description.

For example, an image pyramid structure has five layers. In this case, the first layer is the high-resolution image. The fifth layer is the thumbnail image. Any one of the second layer to the fourth layer is the middle-resolution image. The definition of the middle-resolution image may be different depending on users. For example, the second layer may be defined as the middle-resolution image for a user 1. The third layer may be defined as the middle-resolution image for a user 2. The third layer may be defined as the middle-resolution image also for a user 3. As a result, data conversion may be optimized for each user.

That is, in the above-mentioned example, according to the statistics of observation history until now, the user 1 is likely to observe a thumbnail image of the fifth layer first, to observe the fourth layer next, to observe the third layer next, to observe the second layer finally, and not to observe a high-resolution image of the first layer. It makes sense to define the second layer as the middle-resolution image and to convert the second layer after the thumbnail image is converted, because the user 1 observes the fifth to second layers.

Note that, in this case, a different-company's-format pathological image is converted. As a result, the second layer, which is defined as the middle-resolution image, is created. A pathological image of the third layer and a pathological image of the fourth layer, which have lower resolutions, are created from an image of the second layer based on an algorithm similar to the algorithm of the own-company's format.

Further, the third layer is defined as the middle-resolution image for the user 2. This is based on the following reason. According to the statistics of observation history of the user 2 until now, the user 2 does not browse the second and first layers. Further, the third layer as the middle-resolution image is converted. Because of this, it is not necessary to convert the second layer. The second layer has larger data to be converted than the third layer does. As a result, the conversion time may be shortened.

Next, how to change definition of a middle-resolution image for each user will be described. FIG. 16 is a flowchart for explaining how to change definition of a middle-resolution image for each user.

The display history storage 43 stores display history. First, the middle-resolution image definition holding section 49 obtains the display history via the display history manager 44 (Step S71).

Next, the middle-resolution image definition holding section 49 takes the statistics on display history for each user (Step S72). As the result of this processing, the middle-resolution image definition holding section 49 determines layers, which a specific user observes.

Next, the middle-resolution image definition holding section 49 changes definition of a middle-resolution image for each user based on the statistical result (Step S73). According to this processing, for example, the third layer is defined as the middle-resolution image for the user 3 if the user 3 does not observe the second layer and the first layer. The middle-resolution image definition holding section 49 holds definition of the middle-resolution image, which is different for each user. The middle-resolution image definition holding section 49 provides the held definition to the data conversion section 45 in a case where the data conversion section 45 converts a middle-resolution image.

How to change definition of a middle-resolution image for each user has been described above.

[Other Configurations of Present Application]

Note that the present application may employ the following configurations.

(1) An information processing apparatus, comprising:

a receiving section configured to receive a request for a partial image from a terminal, the partial image being at least a part of a first-format pathological image, the first-format pathological image including a plurality of layers of first images having different resolutions, the terminal being capable of displaying the first-format pathological image;

an obtaining section configured to obtain a layer of second-format pathological image having a resolution corresponding to the received request, the second format being different from the first format;

a conversion section configured to convert the obtained layer of second-format pathological image into a first-format pathological image having a corresponding resolution;

storage configured to store the converted first-format pathological image; and

a responding section configured
to extract the partial image corresponding to the received request from the stored first-format pathological image in response to the received request, and
to reply the partial image to the terminal.
   (2) The information processing apparatus according to (1), wherein

the receiving section is configured to receive the request from the terminal, the request including location information and resolution information of the partial image.

(3) The information processing apparatus according to (1) or (2), wherein

the conversion section is configured to convert at least an encoding scheme of a pathological image.

(4) The information processing apparatus according to (2), further comprising:

a controller configured
to determine if the storage stores the first-format pathological image corresponding to the location information and the resolution information in the received request, and
in a case where the storage fails to store the first-format pathological image, to cause the obtaining section to obtain a layer of pathological image having a resolution corresponding to the resolution information in the received request, and to cause the conversion section to convert the obtained pathological image.
   (5) The information processing apparatus according to (4), wherein

the controller is configured, in a case where the controller determines that the storage stores the first-format pathological image corresponding to the location information and the resolution information in the received request,
to cause the responding section to extract the partial image corresponding to the location information in the received request from the stored first-format pathological image based on the location information in the received request, and
to cause the responding section to reply the partial image to the terminal.
   (6) The information processing apparatus according to any one of (1) to (5), wherein

the first format has a selectable image compression rate,

the information processing apparatus further comprises a dyeing information obtaining section, the dyeing information obtaining section being configured to obtain dyeing information of the first-format pathological image, and

the conversion section is configured to determine an image compression rate used in the conversion based on the obtained dyeing information.

(7) The information processing apparatus according to any one of (1) to (6), wherein

the storage is configured to store a plurality of first-format pathological images, and

the information processing apparatus further comprises an optimization section, the optimization section being configured
to calculate reply frequency of each of the plurality of first-format pathological images to the terminal, and
to delete a layer of image having the highest resolution out of images in each of the plurality of first-format pathological images stored in the storage in ascending order from a first-format pathological image having the calculated lowest frequency for a predetermined threshold number of first-format pathological images.
   (8) The information processing apparatus according to (7), wherein

the optimization section is configured
to calculate the reply frequency of the plurality of pathological images stored in the storage, and
in a case where the layer of image having the highest resolution is deleted, to cause the obtaining section and the conversion section to create an image having a resolution same as the resolution of the deleted image in descending order from a pathological image having the calculated highest frequency for a predetermined threshold number of pathological images, and to store the created image in the storage.
   (9) The information processing apparatus according to any one of (1) to (7), wherein

the request includes a user identifier, the user identifier identifying a user of the terminal, and

the information processing apparatus further comprises a determining section, the determining section being configured
to count frequency of specifying a resolution for each user based on the user identifier and the resolution information in the request, and
to determine a layer to be converted after conversion of a layer having the lowest resolution for each user based on the counted frequency of specifying resolution for each user.
   (10) An information processing method, comprising:

receiving, by a receiving section, a request for a partial image from a terminal, the partial image being at least a part of a first-format pathological image, the first-format pathological image including a plurality of layers of first images having different resolutions, the terminal being capable of displaying the first-format pathological image;

obtaining, by an obtaining section, a layer of second-format pathological image having a resolution corresponding to the received request, the second format being different from the first format;

converting, by a conversion section, the obtained layer of second-format pathological image into a first-format pathological image having a corresponding resolution;

storing, in storage, the converted first-format pathological image; and

extracting, by a responding section, the partial image corresponding to the received request from the stored first-format pathological image in response to the received request, and replying the partial image to the terminal.

(11) An information processing program, causing a computer to function as:

a receiving section configured to receive a request for a partial image from a terminal, the partial image being at least a part of a first-format pathological image, the first-format pathological image including a plurality of layers of first images having different resolutions, the terminal being capable of displaying the first-format pathological image;

an obtaining section configured to obtain a layer of second-format pathological image having a resolution corresponding to the received request, the second format being different from the first format;

a conversion section configured to convert the obtained layer of second-format pathological image into a first-format pathological image having a corresponding resolution;

storage configured to store the converted first-format pathological image; and

a responding section configured
to extract the partial image corresponding to the received request from the stored first-format pathological image in response to the received request, and
to reply the partial image to the terminal.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An information processing apparatus, comprising:
a receiving section configured to receive a request for a partial image from a terminal, the partial image being at least a part of a first-format pathological image, the first-format pathological image including a plurality of layers of first images having different resolutions, the terminal being capable of displaying the first-format pathological image;
an obtaining section configured to obtain a layer of second-format pathological image having a resolution corresponding to the received request, the second format being different from the first format;
a conversion section configured to convert the obtained layer of second-format pathological image into a first-format pathological image having a corresponding resolution;
storage configured to store the converted first-format pathological image; and
a responding section configured
to extract the partial image corresponding to the received request from the stored first-format pathological image in response to the received request, and
to reply the partial image to the terminal.

2. The information processing apparatus according to claim 1, wherein
the receiving section is configured to receive the request from the terminal, the request including location information and resolution information of the partial image.

3. The information processing apparatus according to claim 2, wherein
the conversion section is configured to convert at least an encoding scheme of a pathological image.

4. The information processing apparatus according to claim 3, further comprising:
a controller configured
to determine if the storage stores the first-format pathological image corresponding to the location information and the resolution information in the received request, and
in a case where the storage fails to store the first-format pathological image, to cause the obtaining section to obtain a layer of pathological image having a resolution corresponding to the resolution information in the received request, and to cause the conversion section to convert the obtained pathological image.

5. The information processing apparatus according to claim 4, wherein
the controller is configured, in a case where the controller determines that the storage stores the first-format pathological image corresponding to the location information and the resolution information in the received request,
to cause the responding section to extract the partial image corresponding to the location information in the received request from the stored first-format pathological image based on the location information in the received request, and
to cause the responding section to reply the partial image to the terminal.

6. The information processing apparatus according to claim 5, wherein
the first format has a selectable image compression rate,
the information processing apparatus further comprises a dyeing information obtaining section, the dyeing information obtaining section being configured to obtain dyeing information of the first-format pathological image, and
the conversion section is configured to determine an image compression rate used in the conversion based on the obtained dyeing information.

7. The information processing apparatus according to claim 6, wherein
the storage is configured to store a plurality of first-format pathological images, and
the information processing apparatus further comprises an optimization section, the optimization section being configured
to calculate reply frequency of each of the plurality of first-format pathological images to the terminal, and
to delete a layer of image having the highest resolution out of images in each of the plurality of first-format pathological images stored in the storage in ascending order from a first-format pathological image having the calculated lowest frequency for a predetermined threshold number of first-format pathological images.

8. The information processing apparatus according to claim 7, wherein
the optimization section is configured
to calculate the reply frequency of the plurality of pathological images stored in the storage, and
in a case where the layer of image having the highest resolution is deleted, to cause the obtaining section and the conversion section to create an image having a resolution same as the resolution of the deleted image in descending order from a pathological image having the calculated highest frequency for a predetermined threshold number of pathological images, and to store the created image in the storage.

9. The information processing apparatus according to claim 8, wherein
the request includes a user identifier, the user identifier identifying a user of the terminal, and
the information processing apparatus further comprises a determining section, the determining section being configured
to count frequency of specifying a resolution for each user based on the user identifier and the resolution information in the request, and
to determine a layer to be converted after conversion of a layer having the lowest resolution for each user based on the counted frequency of specifying resolution for each user.

10. An information processing method, comprising:
receiving, by a receiving section, a request for a partial image from a terminal, the partial image being at least a part of a first-format pathological image, the first-format pathological image including a plurality of layers of first images having different resolutions, the terminal being capable of displaying the first-format pathological image;
obtaining, by an obtaining section, a layer of second-format pathological image having a resolution corresponding to the received request, the second format being different from the first format;
converting, by a conversion section, the obtained layer of second-format pathological image into a first-format pathological image having a corresponding resolution;
storing, in storage, the converted first-format pathological image; and
extracting, by a responding section, the partial image corresponding to the received request from the stored first-format pathological image in response to the received request, and replying the partial image to the terminal.

11. An information processing program, causing a computer to function as:
a receiving section configured to receive a request for a partial image from a terminal, the partial image being at least a part of a first-format pathological image, the first-format pathological image including a plurality of layers of first images having different resolutions, the terminal being capable of displaying the first-format pathological image;
an obtaining section configured to obtain a layer of second-format pathological image having a resolution corresponding to the received request, the second format being different from the first format;
a conversion section configured to convert the obtained layer of second-format pathological image into a first-format pathological image having a corresponding resolution;
storage configured to store the converted first-format pathological image; and
a responding section configured
to extract the partial image corresponding to the received request from the stored first-format pathological image in response to the received request, and
to reply the partial image to the terminal.
